(19) United States
(12) Patent Application Publication
(10) Pub. No.: US 2008/0041430 A1
(43) Pub. Date: Feb. 21, 2008

(54) Cleaning solution spraying unit and wafer cleaning apparatus with the same

(75) Inventors: Mo-Hyun Cho, Suwon-si (KR); Duk-Lyol Lee, Hwaseong-si (KR); Kyung-Seuk Hwang, Suwon-si (KR); Dong-Chul Hur, Seongnam-si (KR)

Correspondence Address: MILLS & ONELLO LLP, ELEVEN BEACON STREET, SUITE 605, BOSTON, MA, 02108, US

(73) Assignee: Samsung Electronics Co, Ltd.

(21) Appl. No.: 11/894,543

(22) Filed: Aug. 21, 2007

(30) Foreign Application Priority Data
Aug. 21, 2006 (KR) 10-2006-0078866

(51) Int. Cl. B08B 3/02

(52) U.S. Cl. 134/58 R

(57) ABSTRACT

There is provided a cleaning solution spraying unit. The cleaning solution spraying unit comprises a number of nozzles installed in a nozzle base, along a top surface of a wafer, and radially spraying a cleaning solution on the wafer, wherein the nozzle base is positioned above the wafer; and a power unit rotating the nozzles at a predetermined angle relative to a line extending perpendicularly from the top surface of the wafer. In addition, provided is a wafer cleaning apparatus including the cleaning solution spraying unit with the above-described constitution.

### CROSS-REFERENCE TO RELATED APPLICATION

This application claims priority under 35 U.S.C. 119 from Korean Patent Application No. 10-2006-0078866, filed on Aug. 21, 2006, the disclosure of which is hereby incorporated herein by reference in its entirety as if set forth fully herein.

### BACKGROUND OF INVENTION

1. Technical Field

The present invention relates to a wafer cleaning apparatus, and more particularly, to a cleaning solution spraying unit and a wafer cleaning apparatus with the same.

2. Discussion of the Related Art

Generally, a semiconductor device is fabricated by sequentially or selectively repeating the processes such as diffusion, deposition, photolithography, ion implantation, etching, and cleaning on a wafer.

The photolithography process is used to form a circuit pattern with a predetermined line width on a wafer. The photolithography process will be described in more detail below.

A surface of a wafer is processed, using hexa methyldisilazane (HMDS: (CH₃)₃ Si—N—Si((CH₃)₃)). The surface processing process improves the adhesive strength between the wafer surface and photo-resist. Subsequently, photo-resist is coated, to a predetermined thickness, on the surface of the wafer, using a unit such as a spin coater. The photo-resist is a photosensitive solution exposed by light. A soft bake process is performed on the wafer, to remove solvent remaining during the photo-resist coating process.

An exposure process is performed on the top surface of the wafer after the soft bake process. The exposure process is to minimize and project a circuit pattern formed on a reticle and to form the circuit pattern on the wafer, using light. As the photo-resist coated on the top surface of the wafer is exposed so as to correspond to the shape of the circuit pattern, the circuit pattern is formed on the top surface of the wafer.

Subsequently, when the exposure process using light with a single wavelength is performed, incident light is reinforced or interfered with reflected light on the surface of the wafer. As a result, the size of a wave increases, and the reproducibility of the circuit pattern deteriorates. This is called a standing wave phenomenon. To remove the standing wave phenomenon and to secure the uniformity in the line width of the circuit formed on the top surface of the wafer, a post-exposure bake (PEB) process can be performed.

Subsequently, a development process is performed to finally realize the circuit pattern of the reticle on the top surface of the wafer, by dissolving the photo-resist changed by the exposure process. An alkaline solution is used for the development process. After the development process is completed, a hard bake process is performed to remove water remaining on the wafer and to cure the circuit pattern.

Subsequently, after the hard bake process is completed, the photo-resist is removed, except for the portion where the circuit pattern is formed. The photo-resist removal is generally called a photo-resist strip process. To perform the photo-resist strip process, a polishing system, such as chemical mechanical polishing (CMP), is used. A photo-resist layer is removed by the polishing system, such as the CMP.

After the photo-resist layer is stripped, the photo-resist residue resulted from the photo-resist strip process remains on the top surface of the wafer. The residue acts as a foreign material, such as particles, on the wafer. The photo-resist residue becomes a main reason for causing a product failure.

To remove the photo-resist residue generated after the photo-resist strip process is completed, a wafer cleaning apparatus is used.

Generally, a wafer cleaning apparatus includes a chuck for holding and rotating a wafer; and nozzles positioned above the chuck and spraying a cleaning solution. An angle at which the cleaning solution is sprayed from the nozzles is 0 degrees or is close to 0 degrees relative to a line extending perpendicularly from the top surface of the wafer. The nozzles are typically positioned above the middle of the wafer.

When the cleaning solution is sprayed, at predetermined spraying pressure, from the nozzles toward the middle of the wafer being rotated, the cleaning solution is supplied to the middle top surface of the wafer. The cleaning solution is pushed from the top surface of the rotating wafer to the outside of the wafer by the centrifugal force. Then, the photo-resist residue remaining on the top surface of the wafer is pushed outside the wafer and is discharged.

However, when the cleaning solution is sprayed on the middle of the wafer, at the spray angle being close to about 0 degrees, an amount of the cleaning solution being supplied to the middle of the wafer is relatively greater than an amount of the cleaning solution being supplied to the edge of the wafer. In this case, less the photo-resist residue can be removed at the edge of the wafer, compared to the middle of the wafer.

### SUMMARY OF THE INVENTION

In accordance with the present invention, provided is a cleaning solution spraying unit and a wafer cleaning apparatus including the same, each if which easily removes the photo-resist reside remaining on a wafer after a photo-resist strip process, by spraying a cleaning solution at an angle on the whole surface of the wafer.

Also in accordance with the present invention, provided a cleaning solution spraying unit and a wafer cleaning apparatus including the same, each of which easily removes the photo-resist reside remaining on a wafer after a photo-resist strip process, by sufficiently supplying a cleaning solution on the whole surface of a wafer.

Also in accordance with the present invention, provided is a cleaning solution spraying unit and a wafer cleaning apparatus including the same, each of which improves the transmittance of light to lens when manufacturing an image sensor.

In accordance with an aspect of the present invention, provided is a cleaning solution spraying unit comprising: a set of nozzles installed in a nozzle base supported above a top surface of a wafer, the set of nozzles configured to radially spray a cleaning solution on the wafer; and a power unit configured to rotate the nozzles at a predetermined angle relative to a line extending perpendicularly from the top surface of the wafer.

The angle at which the cleaning solution is sprayed from the nozzles can become progressively larger as the nozzles are positioned away from a center nozzle, with the largest angle being in the outermost nozzles.

The power unit can comprise: a first motor installed at an end of a first rotation shaft being extended from the nozzle base, along a direction in which the nozzles are arranged; and a first controller configured to transmit an electrical signal to the first motor, to rotate the nozzle base at a predetermined rotation angle.

The first controller can be configured to swing the nozzle base within a range of the predetermined angle using the first motor.

The power unit can comprise: a set of third motors installed at a support shaft axially connected to the set of nozzles, so that each third motor is connected to a corresponding nozzle from a set of nozzles; and a third controller configured to transmit an electrical signal to each third motor, to rotate one or more nozzle in the set of nozzles at a predetermined rotation angle.

The third controller can be configured to swing the one or more nozzle in the set of nozzles within a range of the predetermined angle using the third motors such that the cleaning solution is sprayed from the nozzles in a same direction.

The third controller can be configured to swing the one or more nozzle in the set of nozzles within a range of the predetermined angle using the third motors such that the cleaning solution is sprayed from the nozzles in cross directions.

The cleaning solution spraying unit can further comprise: a second motor connected to a second rotation shaft positioned on a middle upper portion of the nozzle base; and a second controller electrically connected to the second motor and configured to rotate the nozzle base at a predetermined rotation speed.

In accordance with another aspect of the present invention, provided is a wafer cleaning apparatus comprising: a spin chuck, on which a wafer is held, configured to be rotated at a first predetermined speed; a nozzle base positioned above the spin chuck and configured to be rotated at a second predetermined speed; a set of nozzles installed in the nozzle base, including nozzle tips configured to radially spray a cleaning solution on a top surface of the wafer; a power unit configured to position the set of nozzles at a predetermined angle relative to a line extending perpendicularly from the top surface of the wafer; and a rotator configured to selectively rotate at least one of the spin chuck and the nozzle base.

The angle at which the cleaning solution is sprayed from the nozzles can become progressively larger as the nozzles are positioned away from a center nozzle, with the largest angle being in the outermost nozzles.

The power unit can comprise: a first motor installed at an end of a first rotation shaft extended from the nozzle base, along a direction in which the nozzles are arranged; and a first controller configured to transmit an electrical signal to the first motor, to rotate the nozzle base at a predetermined rotation angle.

The first controller can be configured to swing the nozzle base within a range of the predetermined angle using the first motor.

The power unit can comprise: a set of third motors installed at a third shaft axially connected to the set of nozzles, so that each third motor is connected to a corresponding nozzle from the set of nozzles; and a third controller configured to transmit an electrical signal to each third motor, to rotate one or more nozzle in the set of nozzles at a predetermined rotation angle.

The third controller can be configured to swing the at least one nozzle from the set of nozzles within a range of the predetermined angle using the third motors such that the cleaning solution is sprayed from the nozzles in a same direction.

The third controller can be configured to swing the at least one nozzle from the set of nozzles within a range of the predetermined angle using the third motors such that the cleaning solution is sprayed from the nozzles in cross directions.

The rotator can comprise: a second motor connected to a second rotation shaft positioned on a middle upper portion of the nozzle base; and a second controller electrically connected to the second motor and configured to rotate the nozzle base at a predetermined rotation speed.

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the invention. In the drawings:

FIG. 1 is a perspective view of an embodiment of a wafer cleaning apparatus with a cleaning solution spraying unit in accordance with an aspect of the present invention;

FIG. 2 is a sectional view taken along line I-I′ of FIG. 1;

FIG. 3 is a side view of an operation of the cleaning solution spraying unit of FIG. 1;

FIG. 4 is a perspective view of an operation of a base arm of FIG. 1;

FIG. 5 is a perspective view of an embodiment of a cleaning solution spraying unit in accordance with another aspect of the present invention;

FIG. 6 is a side view of an operation of the cleaning solution spraying unit of FIG. 5;

FIG. 7 is a sectional view of an embodiment of a spray angle of nozzle tips in the cleaning solution spray unit in accordance with an aspect of the present invention;

FIG. 8 is a bottom view of the nozzle tips of FIG. 7; and

FIG. 9 is a plan view of supply conduits in the nozzles of FIG. 7.

### DETAILED DESCRIPTION OF THE INVENTION

Hereinafter, aspects of the present invention will be described by explaining illustrative embodiments in accordance therewith, with reference to the attached drawings. While describing these embodiments, detailed descriptions of well-known items, functions, or configurations are typically omitted for conciseness. This invention can, however, be embodied in many different forms and should not be construed as being limited to the embodiments set forth herein. Like numbers refer to like elements throughout the specification.

It will be understood that, although the terms first, second, etc. are be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

Spatially relative terms, such as “beneath,” “below,” “lower,” “above,” “upper” and the like may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (e.g., rotated 90 degrees or at other orientations) and the spatially relative descriptors used herein interpreted accordingly.

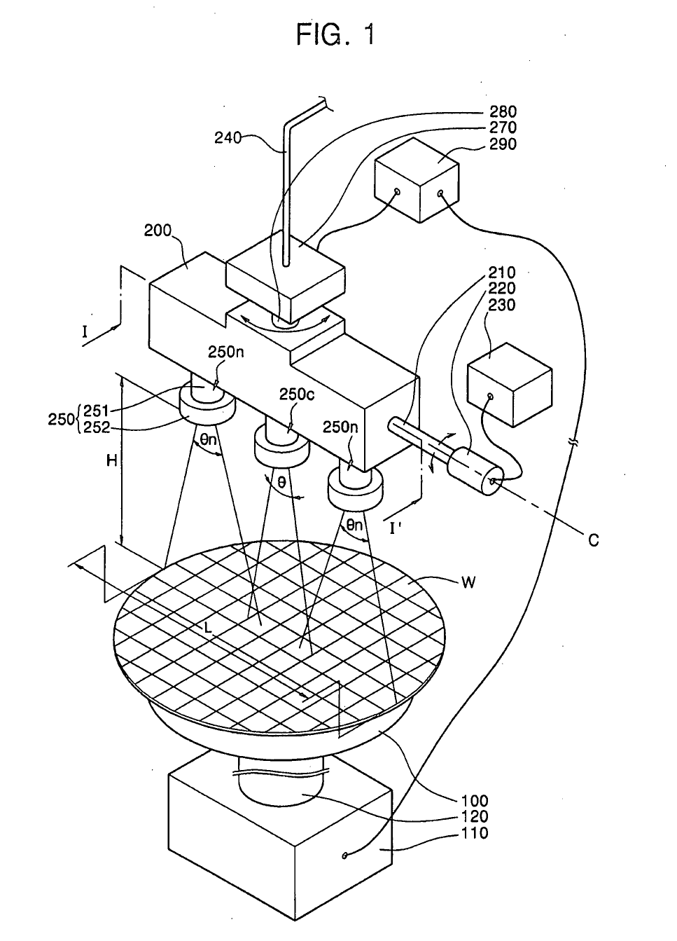

FIG. 1 provides an embodiment of a wafer cleaning apparatus in accordance with an aspect of the present invention, which is configured to spray a cleaning solution on a wafer through a number of nozzles. The cleaning solution is sufficiently supplied to the top surface of the wafer through the nozzles arranged at an angle toward an edge of the wafer. Thus, the wafer cleaning apparatus is capable of easily removing a foreign material remaining on the wafer by the cleaning solution sprayed at an angle.

In this embodiment, the wafer cleaning apparatus of FIG. 1 comprises a spin chuck 100 on which a wafer W is held. A spin motor 110 is positioned under the spin chuck 100. The spin motor 110 includes a motor shaft 120. The motor shaft 120 is connected to the bottom of the spin chuck 100. A nozzle base 200 is positioned above the spin chuck 100.

The wafer cleaning apparatus comprises a cleaning solution spraying unit. The cleaning solution spraying unit is positioned above the wafer W, along the top surface of the wafer W. The cleaning solution spraying unit comprises nozzle base 200, a set of nozzles (generally referred to as nozzle or nozzles 250) configured to radially spray a cleaning solution on the wafer; and a power unit rotating the nozzles 250 at a predetermined angle relative to a line extending perpendicularly from the top surface of the wafer W.

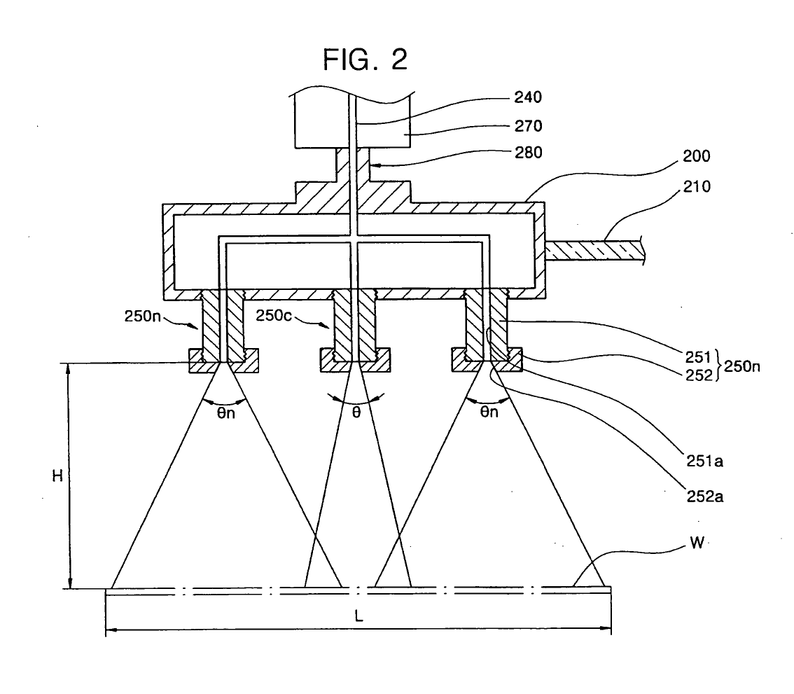

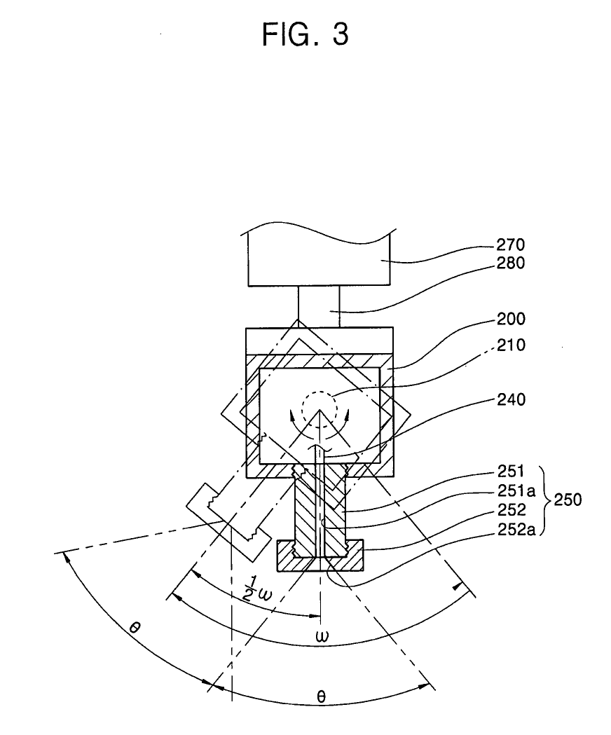

The power unit comprises a first rotation shaft 210, a first motor 220, and a first controller 230. The first rotation shaft extends from a side of the nozzle base 200. The other end of the first rotation shaft 210 is connected to the first motor 220. The first motor 220 is electrically connected to the first controller 230. The first controller 230 controls a rotation angle co of the first rotation shaft 210. A number of nozzles 250, which in this embodiment are arranged in a line and spaced from one another at a predetermined interval, are installed at the bottom of the nozzle base 200. Each nozzle 250 includes a nozzle body 251 and a supply conduit 251a (see FIGS. 2 and 3) in a hollow shape which perforates through the inside of the nozzle body 251. A nozzle tip 252 is installed at each nozzle 250, and a spray angle θ is formed in the nozzle tip 252. Each nozzle tip 252 includes a spray opening 252a (see FIGS. 2 and 3) being operatively connected to the supply conduit 251a. Each spray opening 252a forms a different spray angle (generally referred to as spray angle θ) in this embodiment. Preferably, a spray angle θ of the cleaning solution sprayed from the nozzles 250 can combine to cover the whole surface of the wafer W, as is shown in FIGS. 1 and 2.

In addition, the wafer cleaning apparatus further comprises a rotator configured to selectively rotate the spin chuck 100 or the nozzle base 200.

In this embodiment, the rotator includes a second motor 270 positioned above the nozzle base 200. The second motor 270 is connected to the top portion of the nozzle base 200 by a second rotation shaft 280. The second motor 270 is electrically connected to a second controller 290. The second controller 290 transmits a driving signal to the second motor 270, and the second motor 270 receiving the driving signal rotates the nozzle base 200 at a predetermined rotation speed. Preferably, the predetermined rotation speed can correspond to the rotation speed of the spin chuck 100.

The second controller 290 is also electrically connected to the spin motor 110. The second controller 290 selects any one of the spin motor 110 and the second motor 270 and drives a selected one. Preferably, the rotation speed of the spin chuck 100 or the nozzle base 200, which is rotated by the electrical signal transmitted from the second controller 290, are the same, in this embodiment.

As illustrated in FIG. 2, the nozzles 250 are connected to a tube 240 for supplying a cleaning solution. One end of the tube 240 is connected to a cleaning solution supply unit (not shown). The other end of the tube 240 penetrates through the second motor 270 and the second rotation shaft 280 connected to the second motor 270, thereby being positioned inside the nozzle base 200. The tube 240 positioned inside the nozzle base 200 is divided to be connected to each nozzle 250. The tube 240 is operatively connected to the supply conduit 25la of each nozzle 250.

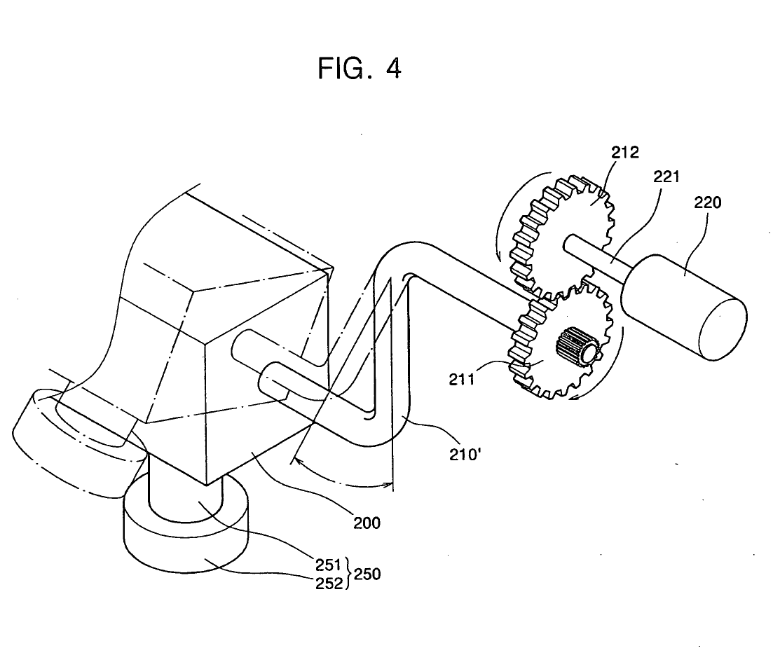

In FIG. 4, there is provided an embodiment of the first rotation shaft 210 in the form of first rotation shaft 210′, having a bend therein. First rotation shaft 210′ is formed at a position being extended from a side of the nozzle base 200 and being spaced apart from the central axis of the nozzle base 200. That is, one end of the first rotation shaft 210′ is connected to the side of the nozzle base 200, and the other end of the first rotation shaft 210′ is spaced apart from the side of the nozzle base 200. The first rotation shaft 210′ includes a first gear 211. The first gear 211 engages with a second gear 212. The second gear 212 is connected to the first rotation shaft 210′, and the first rotation shaft 210′ is rotated by the first motor 220. The first motor 220 is electrically connected to the first controller 230 (shown in FIG. 1).

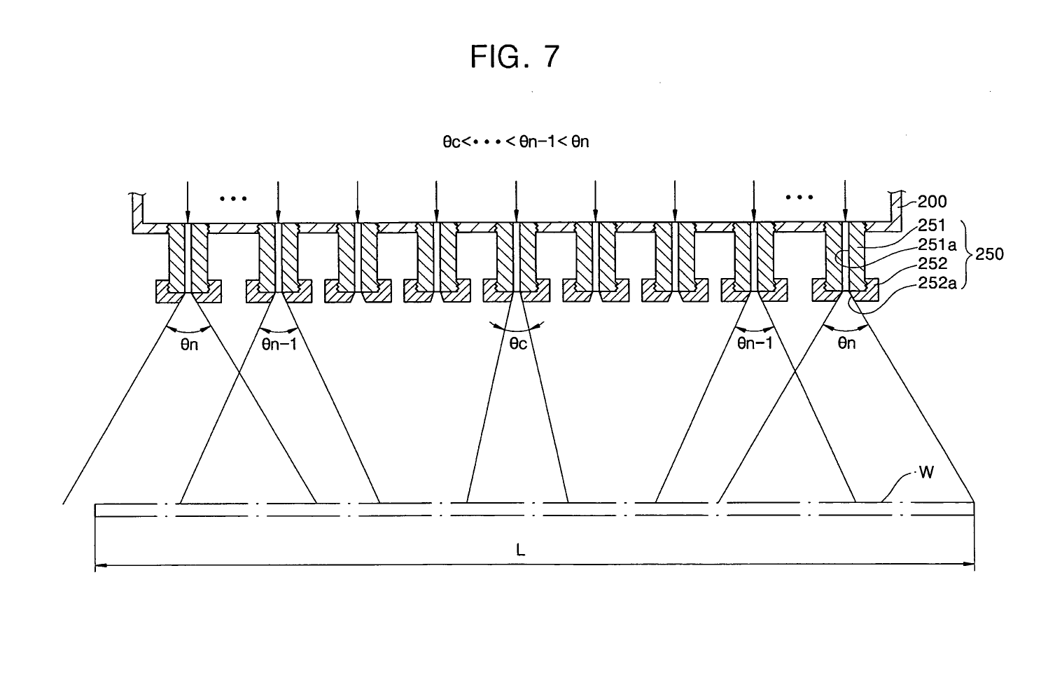

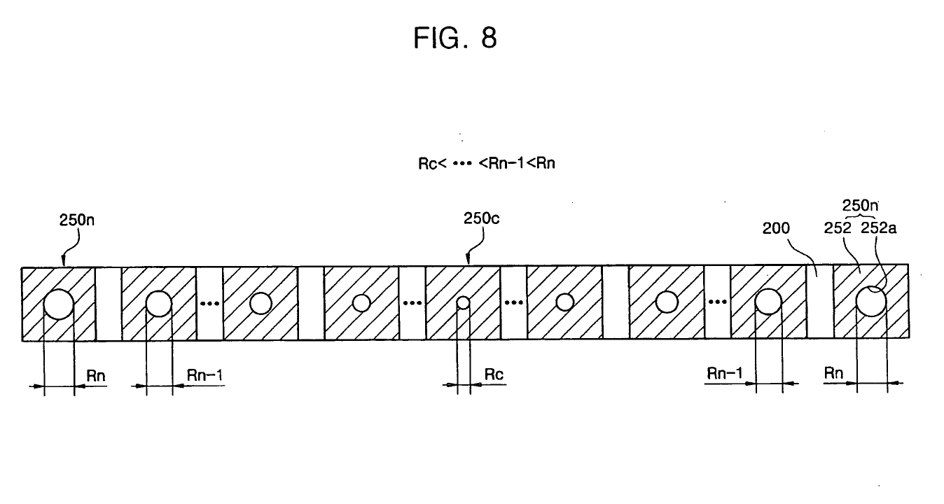

FIG. 8 is a bottom view of the nozzle tips 252 of the nozzles 250 of FIG. 7. As illustrated in the embodiment of FIG. 8, the nozzle tips 252, including the spray openings 252a, are connected to the ends of the nozzles 250, respectively. The diameter ‘Rc’ of the spray openings 252a becomes progressively larger (Rc< . . .<Rn−1<Rn) as the nozzles 250 are progressively positioned away from the center nozzle 250c. That is, the spray opening 252a of the center nozzle 250c has the smallest diameter, and the spray openings 252a of the most outer nozzles 250n have the largest diameter. The center nozzle 250c having the spray opening 252a with the smallest diameter is positioned above the middle of the wafer W, and the most outer nozzles 250n having the spray openings 252a with the largest diameter are positioned above the edge of the wafer W, as shown in FIG. 8. Consequently, the spray angle θ of the cleaning solution increases as the nozzles 250 are progressively positioned away from the center nozzle 250c. That is, the spray angle θ of the cleaning solution is smallest in the center nozzle 250c positioned above the middle of the wafer W, and the spray angle θn of the cleaning solution is largest in the most outer nozzles 250n positioned above the edge of the wafer W, as shown in FIG. 7. The cleaning solution comes in contact with the top surface of the wafer W, at a larger angle, at the edge of the wafer W. That is, the photo-resist residue remaining on the top surface of the wafer W is pushed outside the wafer W and is discharged.

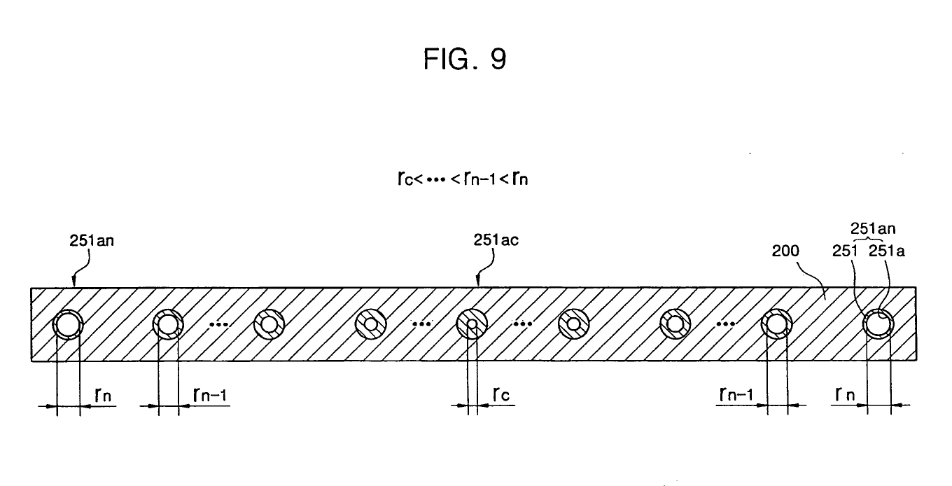

FIG. 9 is a plan view of supply conduits 251a of the nozzles 250 of FIG. 7, which are connected to the tube 240. The supply conduits 251a are connected to the upper ends of the nozzles 250. The diameter ‘rc’ of the supply conduits 251a of the nozzles 250 becomes progressively larger (rc< . . .<rn−1<rn) as the nozzles 250 are progressively positioned away from the center nozzle 250c. That is, the supply conduit 251ac of the center nozzle 250c has the smallest diameter, and the supply conduits 251an of the most outer nozzles 250n have the largest diameter. The center nozzle 250c having the supply conduit 251ac with the smallest diameter is positioned above the middle of the wafer W, and the most outer nozzles 250n having the supply conduits 251an with the largest diameter are positioned above the edge of the wafer W, as shown in FIG. 9. Thus, a difference in the spraying pressure of the nozzles 250 is reduced. That is, the nozzles 250 spray the cleaning solution at a substantially uniform spraying pressure in this embodiment.

An embodiment of an operation of the wafer cleaning apparatus in accordance with aspects of the present invention will be described with reference to the aforementioned constitution.

Referring to FIG. 1, a number of image elements (not shown), which complete a color filter strip process, are formed on the wafer W. As a result, the photo-resist residue remains in the lens on the wafer W.

The second controller 290 selects the second motor 220 or the spin motor 110. Here, the spin motor 110 is selected as an example.

The second controller 230 transmits, to the spin motor 110, an electrical signal to rotate the spin chuck 100 at a predetermined rotation speed. The spin motor 110 rotates the spin chuck 100 connected to the motor shaft 120 at the predetermined rotation speed. Accordingly, the wafer W held on the spin chuck 100 is rotated at the predetermined rotation speed.

The first controller 230 transmits an electrical signal to the first motor 220, so that the first rotation shaft 210 is rotated at a predetermined angle. The rotation angle of the first rotation shaft 210 can predetermined in the first controller 230 or could be input through any additional input device (not shown). The nozzle base 200 connected to the first rotation shaft 210 is rotated at the same rotation angle as the first rotation shaft 210. Then, a number of nozzles 250, which are arranged in a line at the bottom of the nozzle base 200, are rotated at a predetermined angle in one direction on the basis of the top surface of the wafer W.

Subsequently, a predetermined amount of a cleaning solution is supplied from a cleaning solution supply unit to the supply conduit 251a of each nozzle 250. The cleaning solution supplied to each supply conduit 251a is sprayed through each nozzle tip 252 installed at the end of the nozzle 250. As illustrated in FIGS. 1 and 2, from the center nozzle 250c positioned above the middle of the wafer W, the cleaning solution is radially sprayed on the wafer W at an angle of θ. From each nozzle 250n positioned above the edge of the wafer W, the cleaning solution is radially sprayed on the wafer W at an angle of θn, wherein θn is larger than θ.

The cleaning solution sprayed from the nozzles 250 is sufficiently supplied to the whole surface of the wafer W.

Specifically, as illustrated in FIG. 3, when the nozzle 250 is rotated at an angle of ½ ω from a line extending perpendicularly fromthe top surface of the wafer W, the cleaning solution is radially sprayed toward the top surface of the wafer W, due to the spray angle θ of the nozzle tip 252. By the cleaning solution sprayed, at an angle, on the top surface of the wafer W, a pushing force acts on the wafer W. The force pushes foreign material remaining on the top surface of the wafer W outside or off the wafer W. The centrifugal force is generated from the rotating wafer W itself. These forces act on the top surface of the wafer W.

Consequently, the photo-resist residue remaining on the wafer W is easily discharged outside or off of the wafer W, by the above-described forces and the sufficient supply of the cleaning solution.

As the photo-resist residue remaining on the lens during the image element process is easily removed, the transmittance of light to the lens is improved.

As described above, the second controller 290 can select the spin chuck 100 rotating the wafer W at the predetermined rotation speed, but it can also (or alternatively) select the second motor 270. When the second motor 270 is selected, the second controller 290 transmits an electrical signal to the second motor 270. The second motor 270 rotates the second rotation shaft 280 at a predetermined rotation speed. The nozzle base 200 axially connected to the second rotation shaft 280 is rotated at a predetermined rotation speed.

The pushing force acts on the wafer W by the cleaning solution radially being sprayed at an angle. In addition, as the nozzle base 200 is rotated, the spray angle θ of the cleaning solution being radially sprayed becomes larger. Then, the cleaning solution is sufficiently supplied to the top surface of the wafer W.

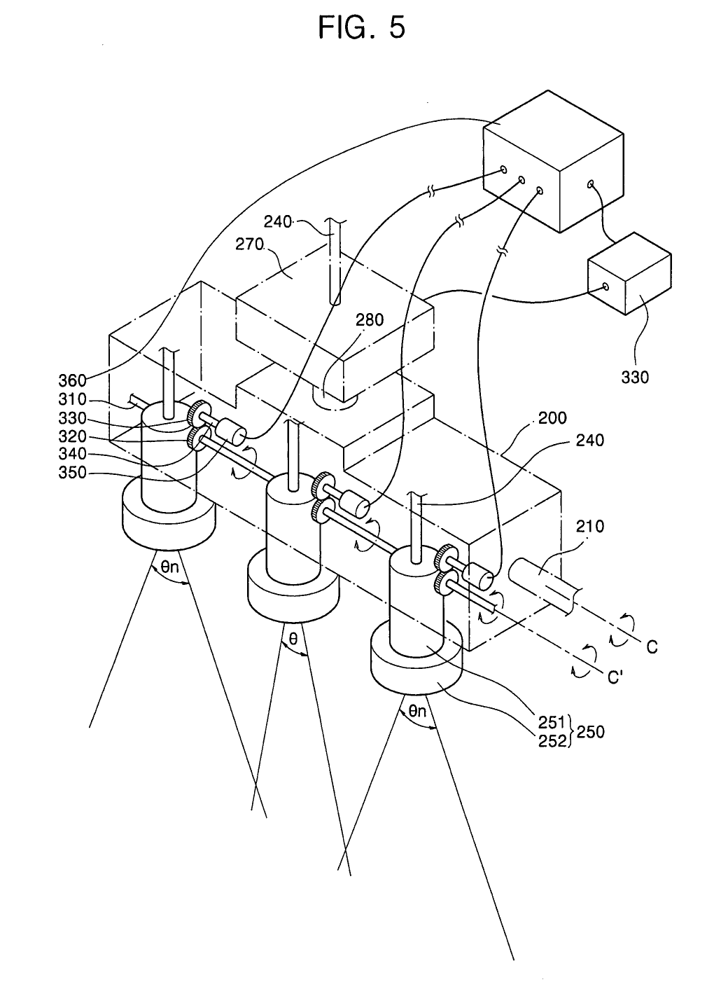

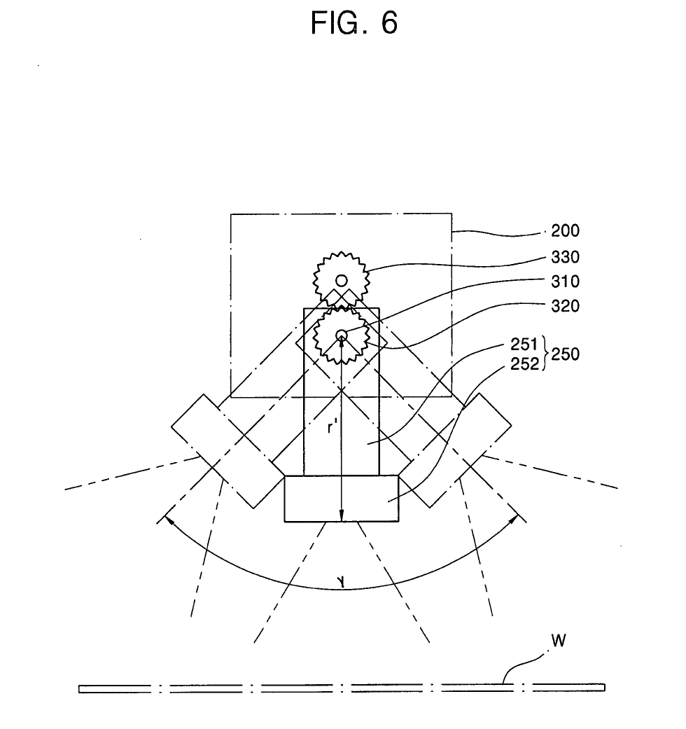

An embodiment of a wafer cleaning apparatus in accordance with another aspect of the present invention will be described in reference to FIGS. 5 and 6.

The wafer cleaning apparatus in accordance with this embodiment comprises the nozzle base 200, like the wafer cleaning apparatus in accordance with the embodiment shown in FIGS. 1 through 4. A support shaft 310 is installed lengthwise inside the nozzle base 200, i.e., along the length direction of the nozzle base 200. The support shaft 310 is positioned to have an axial line C′ parallel to an axial line C of the first rotation shaft 210.

The support shaft 310 penetrates through a number of nozzles 250 to be rotatably supported. A number of first driving gears 320 are installed about the support shaft 310. Each first driving gear 320 is fixed to a side of each nozzle 250. The first driving gears 320 are engaged with the second driving gears 330. Each second driving gear 330 includes a third rotation shaft 340 being extended from the center of the second driving gear 330. The other end of the third rotation shaft 340 is connected to a third motor 350.

Each third motor 350 is electrically connected to a third controller 360. A rotation angle range γ of the nozzles 250 is set in the third controller 360. The third controller 360 can determine a rotation angle of each nozzle 250. The third controller 360 transmits an electrical signal to each third motor 350, to independently drive the third motors 350. That is, each third motor 350 rotates each third rotation shaft 340, so that the rotation angle is differently formed in each nozzle 250.

Further, the third controller 360 transmits an electrical signal to each third motor 350, to swing each third rotation shaft 340 within the rotation angle range.

Since the constitution of the nozzle 250 and the spray angle θ of the nozzle tip 252 are same as those of the embodiment of FIGS. 1 through 4, any further description thereof will not be presented again here.

An operation of the wafer cleaning apparatus in accordance with the embodiment of FIGS. 5 and 6 will be described with reference to the constitution of the wafer cleaning apparatus described above.

Referring to FIGS. 5 and 6, the first controller and the second controller of the wafer cleaning apparatus can be same as those of the wafer cleaning apparatus in accordance with the embodiment of FIGS. 1 through 4.

The third controller 360 transmits a driving signal to the third motors 350, respectively. The driving signal transmitted to each third motor 350 can be a signal to rotate each third rotation shaft 340 at a different rotation angle. The third motors 350 receiving the driving signals respectively rotate the third rotation shafts 340 at their predetermined rotation angle. Each second driving gear 330 connected to the other end of each third rotation shaft 340 is rotated at a determined rotation angle. Each second driving gear 330 is linked with its corresponding first driving gear 320.

Then, each nozzle 250 fixed to a side of each first driving gear 320 is linked with the rotation of its corresponding first driving gear 320. Consequently, the nozzles 250 are rotated at the predetermined rotation angle. Then, the third controller 360 rotates each nozzle 250 at a selectively determined rotation angle.

The determined rotation angle can be different among the nozzles or they can be the same as one another. When the determined rotation angle of the nozzles 250 is the same, the nozzles 250 are linked with the rotation operation, to be rotated at the same rotation angle.

When the determined rotation angle of the nozzles 250 is different, the rotation angle can be different while the rotation direction is the same, or the rotation direction is opposite to each other and the rotation angle can be different. In this case, the nozzles 250 are rotatably supported by the support shaft 310, but are rotated in different directions at the predetermined angle. For example, different nozzles can be directed to spray in cross directions.

When the nozzles 250 are rotated around the support shaft 310 at a predetermined angle by the third controller 360, and the nozzle base 200 is rotated around the first rotation shaft 210 at a predetermined angle by the second controller 290, the spray angle θ of the cleaning solution radially sprayed from the nozzle tip 252 of each nozzle 250 becomes larger with respect to the top surface of the wafer W.

Then, the photo-resist residue remaining on the top surface of the wafer W is easily pushed outside and off of the wafer W, by the cleaning solution sprayed at an angle on the wafer. In addition, since the spray angle θ of the cleaning solution sprayed from the nozzles 250 covers the whole top surface of the rotating wafer W, a sufficient amount of the cleaning solution is supplied to the top surface of the wafer W.

Furthermore, the nozzles 250 installed in the nozzle base 200 can be rotatably positioned at a predetermined angle relative to a line extending perpendicularly from the top surface of the wafer W, as described above. However, it is possible to swing the nozzle base 200 within the range of a predetermined angle or to swing the nozzles 250 around the support shaft 310 within the range of a predetermined angle.

In this case, the cleaning solution is sufficiently supplied to the top surface of the rotating wafer W, and the cleaning solution sprayed at an angle relative to the top surface of the wafer W is reciprocally supplied within a predetermined distance, thereby improving the washing performance of the cleaning solution on the top surface of the wafer W.

As described above, the present invention has an effect in that the photo-resist residue remaining on the wafer after the photo-resist strip process is easily removed by spraying, at an angle, the cleaning solution on the whole surface of the wafer.

Further, the present invention has another effect in that the photo-resist residue is easily removed by sufficiently supplying the cleaning solution on the whole surface of the wafer.

Further, the present invention has another effect in that, when manufacturing an image sensor, the transmittance of light to the lens is improved by easily removing the photo-resist residue remaining on the lens.

The present invention has been described with reference to the embodiments illustrated in the drawings. However, it is to be understood that the scope of the invention is not limited to the disclosed embodiments. On the contrary, the scope of the invention is intended to include various modifications and alternative arrangements within the capabilities of persons skilled in the art using presently known or future technologies and equivalents. The scope of the claims, therefore, should be accorded the broadest interpretation so as to encompass all such modifications and similar arrangements. It is intended by the following claims to claim that which is literally described and all equivalents thereto, including all modifications and variations that fall within the scope of each claim.

What is claimed is:

1. A cleaning solution spraying unit comprising:
a set of nozzles installed in a nozzle base supported above a top surface of a wafer, the set of nozzles configured to radially spray a cleaning solution on the wafer; and
a power unit configured to rotate the nozzles at a predetermined angle relative to a line extending perpendicularly from the top surface of the wafer.

2. The cleaning solution spraying unit according to claim 1, wherein the angle at which the cleaning solution is sprayed from the nozzles becomes progressively larger as the nozzles are positioned away from a center nozzle, with the largest angle being in the outermost nozzles.

3. The cleaning solution spraying unit according to claim 1, wherein the power unit comprises:
a first motor installed at an end of a first rotation shaft extended from the nozzle base, along a direction in which the nozzles are arranged; and
a first controller configured to transmit an electrical signal to the first motor, to rotate the nozzle base at a predetermined rotation angle.

4. The cleaning solution spraying unit according to claim 3, wherein the first controller is configured to swing the nozzle base within a range of the predetermined angle using the first motor.

5. The cleaning solution spraying unit according to claim 1, wherein the power unit comprises:
a set of third motors installed at a support shaft axially connected to the set of nozzles, so that each third motor is connected to a corresponding nozzle from the set of nozzles; and
a third controller configured to transmit an electrical signal to each third motor, to rotate one or more nozzle in the set of nozzles at a predetermined rotation angle.

6. The cleaning solution spraying unit according to claim 5, wherein the third controller is configured to swing the one or more nozzle in the set of nozzles within a range of the predetermined angle using the third motors such that the cleaning solution is sprayed from the nozzles in a same direction.

7. The cleaning solution spraying unit according to claim 5, wherein the third controller is configured to swing the one or more nozzle in the set of nozzles within a range of the predetermined angle using the third motors such that the cleaning solution is sprayed from the nozzles in cross directions.

8. The cleaning solution spraying unit according to claim 1, further comprising:
a second motor connected to a second rotation shaft positioned on a middle upper portion of the nozzle base; and
a second controller electrically connected to the second motor and configured to rotate the nozzle base at a predetermined rotation speed.

9. A wafer cleaning apparatus comprising:
a spin chuck, on which a wafer is held, configured to be rotated at a first predetermined speed;
a nozzle base positioned above the spin chuck and configured to be rotated at second a predetermined speed;
a set of nozzles installed in the nozzle base, including nozzle tips configured to radially spray a cleaning solution on a top surface of the wafer;
a power unit configured to position the set of nozzles at a predetermined angle relative to a line extending perpendicularly from the top surface of the wafer; and
a rotator configured to selectively rotate at least one of the spin chuck and the nozzle base.

10. The wafer cleaning apparatus according to claim 9, wherein the angle at which the cleaning solution is sprayed from the nozzles becomes progressively larger as the nozzles are positioned away from a center nozzle, with the largest angle being in the outermost nozzles.

11. The wafer cleaning apparatus according to claim 9, wherein the power unit comprises:
a first motor installed at an end of a first rotation shaft extended from the nozzle base, along a direction in which the nozzles are arranged; and
a first controller configured to transmit an electrical signal to the first motor, to rotate the nozzle base at a predetermined rotation angle.

12. The wafer cleaning apparatus according to claim 11, wherein the first controller is configured to swing the nozzle base within a range of the predetermined angle using the first motor.

13. The wafer cleaning apparatus according to claim 9, wherein the power unit comprises:
a set of third motors installed at a third shaft axially connected to the set of nozzles, so that each third motor is connected to a corresponding nozzle from the set of nozzles; and
a third controller configured to transmit an electrical signal to each third motor, to rotate one or more nozzle in the set of nozzles at a predetermined rotation angle.

14. The wafer cleaning apparatus according to claim 13, wherein the third controller is configured to swing the at least one nozzle in the set of nozzles within a range of the predetermined angle using the third motors such that the cleaning solution is sprayed from the nozzles in a same direction.

15. The wafer cleaning apparatus according to claim 13, wherein the third controller configured to swing the at least one nozzle in the set of nozzles within a range of the predetermined angle using the third motors such that the cleaning solution is sprayed from the nozzles in cross directions.

16. The wafer cleaning apparatus according to claim 9, wherein the rotator comprises:
a second motor connected to a second rotation shaft positioned on a middle upper portion of the nozzle base; and
a second controller electrically connected to the second motor and configured to rotate the nozzle base at a predetermined rotation speed.
